(19) United States
(12) Patent Application Publication
(10) Pub. No.: US 2007/0207362 A1
(43) Pub. Date: Sep. 6, 2007

(54) Freeze capable compact fuel cell system with improved humidification and removal of excess water and trapped nitrogen

(76) Inventors: Andreas Koenekamp, Darmstadt (DE); Reiner Essinger, Lauteral (DE); Franz Winter, Mainz (DE)

Correspondence Address: GENERAL MOTORS CORPORATION;LEGAL STAFF, MAIL CODE 482-C23-B21, P O BOX 300, DETROIT, MI, 48265-3000, US

(21) Appl. No.: 11/368,307

(22) Filed: Mar. 3, 2006

(51) Int. Cl. H01M 8/02; H01M 8/10; H01M 8/24

(52) U.S. Cl. 429/34; 429/38; 429/30

(57) ABSTRACT

A freeze capable compact fuel cell system to facilitate improved humidification in dry operating conditions and improved freeze capability as well as to facilitate improved removal of excess water and trapped nitrogen gas from the fuel cell system. The fuel cell system is particularly adapted for integration into a small vehicle body.

### TECHNICAL FIELD

This invention relates to compact PEM fuel cell systems that are freeze capable and provide for improved humidification as well as improved removal of excess water and trapped nitrogen gas. The compact PEM fuel cell systems of the present invention are especially suitable for integration into small vehicle bodies.

### BACKGROUND OF THE INVENTION

Fuel Cells have been proposed as a power source for many applications. Proton Exchange Membrane (PEM) fuel cells exhibit attractive characteristics of high energy and low weight and are therefore very desirable for use as power plants in electric vehicles. PEM fuel cells include a thin, proton transmissive solid polymer membrane electrolyte having an anode on one of its faces and a cathode on the opposite face. The membrane in a PEM fuel cell is typically made from a poly sulfonic acid or poly[perfluorinated] sulfonic acid monomer that is polymerized into a copolymer. The PEM is sandwiched between a pair of electrically conductive elements that serve as current collectors for the anode and the cathode, and contain the appropriate channels for distributing the fuel cell's gaseous reactants over the surfaces of the respective anode and cathode catalysts. The channels for the reactants are referred to as flow channels. A plurality of individual fuel cells is commonly bundled together to form a PEM fuel cell stack.

The anode and the cathode typically comprise finely divided catalytic particles, supported on carbon particles, and admixed with proton conductive resin. The catalytic particles are typically precious metals, such as platinum. The entire assembly of catalysts and PEM is known in the art as the membrane electrode assembly (MEA) and is therefore quite expensive to make. Moreover, MEAs require controlled operating conditions in order to prevent degradation of the membrane and catalysts. Among the conditions that degrade fuel cell operation are freeze start conditions, excess water, improper humidification, control of catalysts fouling and venting of excess gasses that migrate between the cathode and anode sides of the fuel cell stack. It has been a particular concern that nitrogen from ambient air used as the oxygen source on the cathode side of the fuel cell stack can migrate across the PEM and accumulate in the anode side of the fuel cell stack. The accumulation of nitrogen gas can affect the efficiency of the fuel cell stack. It has been determined that up to 60% of the anode gas volume is comprised of inert gases. It has therefore been an advantage to exhaust the excess nitrogen from the anode. In addition, residual water can accumulate in the anode side of the fuel cell stack and affect the efficiency of the fuel cell.

In the past, it has been customary to dispose of these gases at the anode exhaust. Because the anode gas exhaust necessarily contains residual hydrogen gas, it is necessary to use a special catalytic combustion device to dispose of the hydrogen in an environmentally permissible manner.

U.S. Pat. No. 6,794,068 to Rapaport et al, issued Sep. 21, 2004 addresses some of these problems by providing for each of the cells in each segment to be arranged such that the reactant gas passages of each cell are in parallel with each other cell. Flow of the fuel cell fluid, normally in a gaseous state on the anode and the cathode side of each cell, is in a gravity assisted downward direction. Gravity assisted flow directs water formed in each cell to lower removal points of the stack segments. Each pair of segments is separated by a separator segment having a separator channel, the separator segment forming an integral unit within the stack. Each separator channel redirects the entire flow of each fluid within the stack from the bottom of an upstream segment to the top of a next or downstream segment, without reacting the fluid, controlling relative humidity between the stack segments.

Moreover, fuel cell design has faced challenges in operation in dry or cold environments. Specifically, proper humidification can be an issue in dry climates or dry starting conditions, as the cathode inlet and the PEM must be properly humidified on starting to ensure peak operation of the fuel cell stack. In addition, excess water in the anode exhaust line or the anode side of the fuel cell stack can freeze in cold condition, making starting the fuel cell more difficult.

A number of references disclose various aspects of fuel cells and their design. Among those are U.S. Pat. No. 5,272,017 to Swathirajan et al, issued Dec. 21, 1993; U.S. Pat. No. 5,316,871 to Swathirajan et al issued May 31, 1994; U.S. Pat. No. 5,478,662 to Strasser, issued Dec. 26, 1995 and U.S. Pat. No. 5,763,113 to Meltser et al, issued Jun. 9, 1998.

### SUMMARY OF THE INVENTION

The present invention is directed to a freeze compatible compact fuel cell system to facilitate improved humidification of the fuel cell at start and during operation, as well as to facilitate removal of excess water and trapped nitrogen gas from the anode side of the fuel cell system.

The present invention is further directed to a freeze compatible fuel cell system with a merged, integrated anode outlet in fluid connection with a water separator which in turn is in fluid connection with the cathode inlet to facilitate improved humidification of the cathode inlet at start conditions.

The present invention is further directed to a design for a fuel cell system that has a short fluid connection between a merged anode outlet and a water separator and a short connection between the water separator and the cathode inlet to minimize freeze condition start difficulties.

The present invention is further directed to a freeze capable compact fuel cell system design for small vehicles to facilitate integration of the fuel cell system with a vehicle body. Preferred variants of the fuel cell systems of the present invention may be found upon a reading of the subordinate claims and the following description.

### BRIEF DESCRIPTION OF THE DRAWINGS

The invention may be better understood when considered in light of the following detailed description thereof that is given hereafter in conjunction with the following drawings of which:

FIG. 1 is schematic of a bipolar PEM fuel stack and a monitoring system therefor.

FIG. 2 is a schematic representation of a PEM fuel cell of the present invention.

FIG. 3 is a perspective view of the fuel cell system of the present invention as adapted for integration in a small vehicle body.

### DETAILED DESCRIPTION OF THE PREFERRED EMBODIMENT(S)

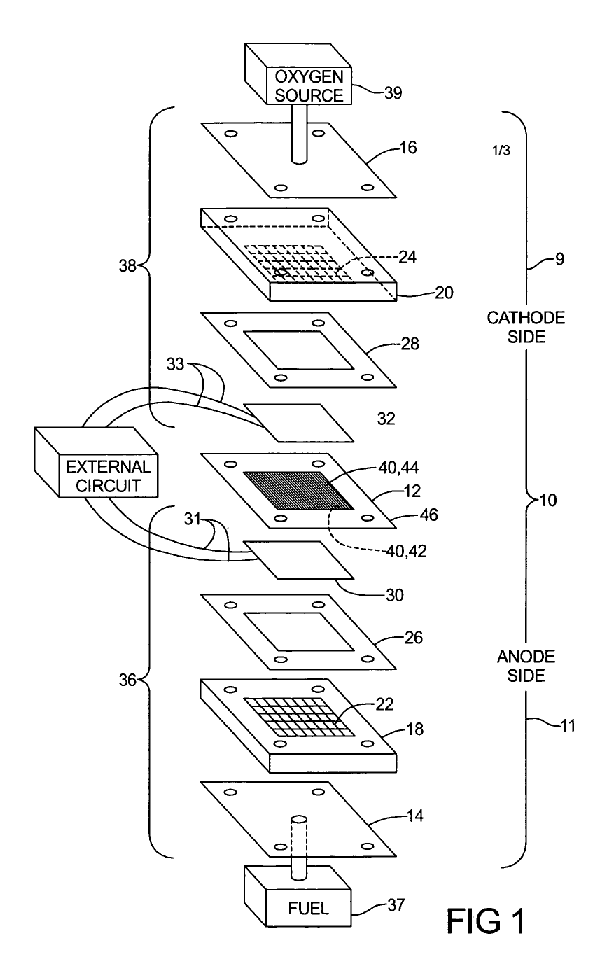

Turning now to the drawings wherein like numerals refer to like structures, and particularly to FIG. 1, there is shown a fuel cell 10 with a combination membrane electrolyte and electrode assembly (MEA) 12 incorporated therein is shown in pictorial unassembled form. Fuel cell 10 comprises endplates 14, 16, respectively, graphite blocks 18, 20, with openings 22, 24 to facilitate gas distribution, gaskets 26, 28, carbon cloth current collectors 30, 32, with respective connections 31, 33 and the membrane electrolyte and electrode assembly (MEA) 12. The two sets of graphite blocks, gaskets, and current collectors, namely 18, 26, 30 and 20, 28, 32 are referred to as perspective gas and current transport means 36, 38. Anode connection 31 and cathode connection 33 are used to interconnect with an external circuit and may include other fuel cells.

Fuel cell 10 includes gaseous reactants, one of which is fuel supplied from fuel source 37, which may be hydrogen or a hydrogen containing gas, and another is an oxidizer, such as oxygen or an oxygen containing gas, supplied from source 39. The gases from sources 37, 39 diffuse through respective gas and current transport means 36 and 38 to opposite sides of the MEA 12. In addition, it can be seen by reference to FIG. 1 that fuel cell 10 is comprised of a cathode side 9 and an anode side 11. Porous electrodes 40 form anode 42 at the fuel side and cathode 44 of the oxygen side. Anode 42 is separated from cathode 44 by Proton Exchange Membrane (PEM) 46. PEM 46 provides for ion transport to facilitate reactions in fuel cell 10. A typical membrane commercially available is NAFION® sold by E.I. Dupont de Nemours & Co. Another is sold by Dow Chemical. The PEMs are made of copolymers of suitable monomers to form the membranes. Such proton exchange membranes may be characterized by monomers of the structures: 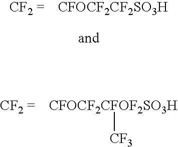
Those skilled in the art will recognize this typical structure is disclosed in detail by Swarthirajan et al, U.S. Pat. No. 5,316,871, incorporated herein by reference as if fully disclosed.

A fuel cell stack is constructed of a plurality of fuel cells that are paired together. These pairs are joined together into stacks to form a fuel cell stack that is contemplated for use as a power plant for the generation of electric power for vehicles.

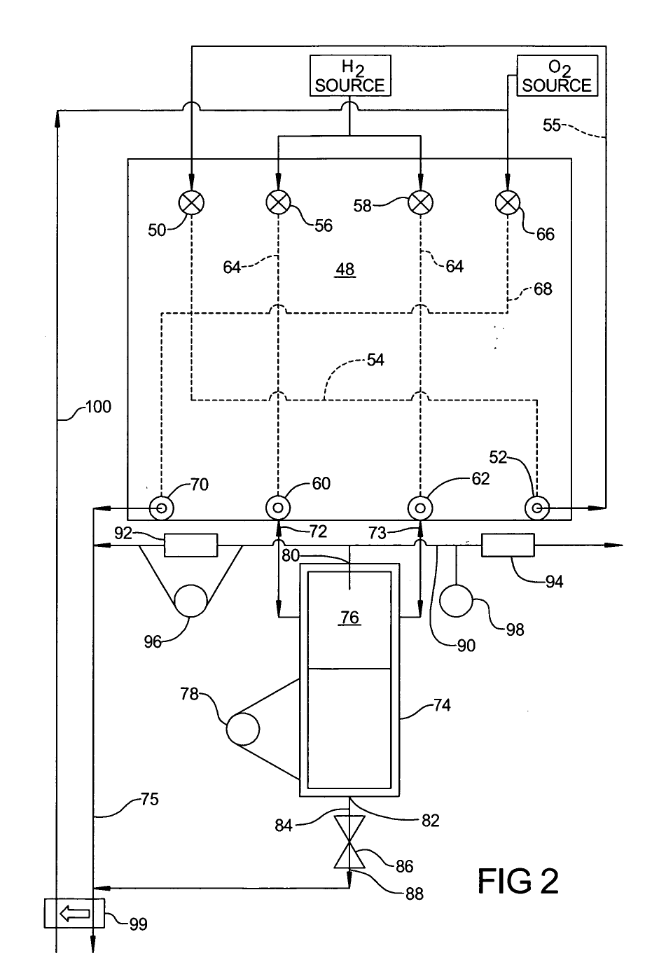

Turning to FIG. 2, there is shown therein a schematic representation of a fuel cell stack and associated components and connections contemplated in the present invention.

Fuel cell stack 48 is, as stated above, comprised of a plurality of paired fuel cells joined together in such a way as to permit the efficient generation of electrical power in a compact design. The fuel cell stack has a coolant inlet 50 and a coolant outlet 52 in fluid connection 54 such that the coolant circulated throughout the fuel cell stack to provide efficient cooling of the stack during operation. It is appreciated that the coolant inlet and the coolant outlet are in a closed fluid connection 55 to provide a closed cooling system for the fuel cell stack such as is already understood in the art. In this regard, the coolant closed fluid connection is understood to be a plurality of coolant passages to maximize cooling efficiency. It is contemplated that the operational temperature of the fuel cell stack is in the range of 60 to 80 degrees Celsius, and it is important that efficient cooling of the stack be maintained.

The fuel cell stack is further equipped with integrated anode inlets 56 and 58 that are integrated into the anode side of the fuel cells. Merged integrated anode outlets 60 and 62 are in fluid connection 64 with the anode inlets. While depicted schematically in FIG. 2, it is understood that a plurality of anode fluid connections arranged in a plurality of passages is contemplated to maximize the operation of the anode side fuel cell stack. In addition, the anode fluids are anode exhaust gasses, as well as excess water from the anode side of the fuel cell stack. Cathode inlet 66 is in fluid connection 68 with cathode outlet 70. Again, it is understood that while the cathode fluid connection is shown schematically, those skilled in the art appreciate that a plurality of cathode fluid connections arranged in a plurality of passages are contemplated for the efficient operation of the cathode side of the fuel cell stack. In addition, cathode fluids are cathode exhaust gasses and water from the cathode side of the fuel cell stack. It is important to note that the present invention contemplates the adaptation of a merged integrated anode outlet together with integrated anode inlets to minimize space requirements for placing the fuel cell in difficult locations, such as integrating the fuel cell stack in a small vehicle body.

Merged integrated anode outlets 60 and 62 are in fluid connection 72, 73 with a water separator 74 through a membrane 76. While one membrane is schematically depicted, those skilled in the art will recognize that a plurality of membranes may also be used. The membrane is a water separation membrane and is usually a copolymer of either monomers of poly [perfluorosulfonic] acid, a copolymer of monomers of poly sulfonic acid or some other suitable material to permit the efficient separation of water from the exhaust gases of the anode side of the fuel cell stack. The water separator is further equipped with a fullness sensor indicator 78 that senses the level of in the water separator and transmits that signal to a remote ECM. The ECM contains appropriate software to control the release of water from the separator.

The water separator is further equipped with a first opening 80 in a first end of the separator, and a second opening 82 in a second end of the separator. At its first end, the water separator is equipped with a first opening in fluid connection 90 at a first end with bleed valve 92 and at a second end with purge valve 94. Attendant the bleed valve is differential pressure sensor 96, which controls the flow rate of the bleed valve. The bleed valve is in fluid connection with fluid connection 75 between the cathode outlet and the cathode inlet to permit the recirculation of water from the anode exhaust gas to the cathode inlet to improve humidification during operation of the system. The differential pressure sensor operates to control the flow rate of the bleed valve and is used to vent trapped hydrogen, nitrogen from the anode exhaust gas. It is understood in the art that nitrogen build up on the anode side of a fuel cell is common during operation when the source of oxygen containing gas is ambient air. Air is approximately 80% nitrogen and some of this gas can migrate across the PEM where it can slowly affect the efficiency of the anode side of the fuel cell. The nitrogen build up is well understood and can be calculated and predicted based upon the level of operation of the fuel cell. In this way, the differential pressure sensor is used to control the flow rate of the bleed valve to vent the nitrogen in a predictable manner by signals received from the ECM based upon operation of the fuel cell compared to values of nitrogen and water generation stored in tables within the ECM.

The second end of the fluid connection from the first end of the water separator is equipped with a purge valve to vent excess anode exhaust gasses. The purge valve has a pressure sensor 98 that senses pressure of the anode system to control the purge valve. The purge valve which is an anode pressure valve has two purposes. One purpose is to purge and dry out the anode at shutdown. The second purpose is to act as a pressure relief valve in case of any incident during operation of the fuel cell. The anode pressure valve or purge valve detects the pressure of the anode gasses in the fluid connection 80, and sending a signal to the ECM, which directs the purge valve to open and close as necessary to vent the excess anode exhaust gasses from the fuel cell stack system.

The second opening 82 is in fluid connection 84 with anode drain valve and operates as a cathode water humidification valve 86. The valve 86 is in fluid connection 88 with cathode fluid connection 75. This connection permits the cathode moistener valve to humidify the cathode inlet to provide for improved humidification of the fuel cell stack in a compact design. In addition, the fluid connection between the water separator, the humidity valve and the cathode inlet is constructed as to be as short as possible. This is an important consideration, especially when considering the fuel cell operation in cold or freezing temperatures.

Specifically, it has been a challenge to provide a freeze capable compact fuel cell stack design suitable for incorporation in a small vehicle body for operation in dry conditions or in freezing temperatures. After shut down, water can freeze in the system, especially in the fluid connections between the anode outlet and the cathode outlet. In the past, electric heaters have been employed to warm this connection to melt any frozen water to permit starts of the fuel cell stack in freezing temperatures. Once the system is started, residual heat in the water re-circulated from the anode side through the separator and through fluid connection 72, 73 prevents freeze during operation. By use of the design of the present invention, wherein the connection between the separator, anode outlets and cathode outlet is reduced to its absolute minimum length, the challenge of water freeze has been efficiently addressed, thereby permitting the designer to eliminate electric heating means to heat the fluid connection in cold weather prior to start of the fuel cell stack. This saves space and complexity and permits more efficient integration of the fuel cell stack into a small vehicle body.

The use of the present invention presents several advantages for the development of fuel cell systems that are freeze capable and adaptable for incorporation into small vehicle body designs.

Specifically, during dry operating conditions, or after a fuel cell is shut down, the PEM experiences some drying out which may affect its later efficiency in operation or in start conditions. In addition, in dry operating conditions, if the ambient temperatures are cold, or even freezing, the dryness is accentuated and the PEM may experience a reduced lifetime in dry operating conditions. It has been found that the present design, as described herein, provides the cathode inlet with improved humidification during start and operation in all operating conditions, including dry operating conditions. In addition, the system described has reduced freeze complications which eliminate the need for auxiliary heating units of prior fuel cell designs used for electric vehicles. The system further permits the improved moistening of the PEM and humidification of the cathode inlet to permit efficient operation of the fuel cell stack in a wider range of operating conditions and temperatures.

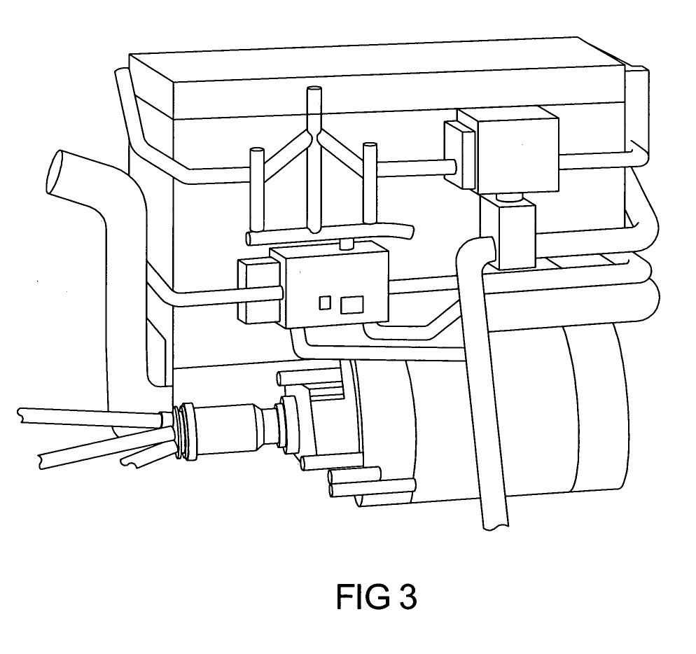

FIG. 3 is a perspective of the fuel cell stack design of the present invention showing its adaptability for incorporation into a small vehicle body. The fuel cell stack is shown with the merged integrated anode outlet for ease of access and service. In addition, the fluid connections from the anode outlet are very short and compact, to reduce the freezing issues previously discussed. In addition, the compact nature of the fluid connections permits the elimination of auxiliary heating elements for cold weather applications. The orientation of components, as well as the elimination of components allows ease of integration of the compact fuel cell design described into small vehicle bodies.

While the embodiments described herein are directed to several different aspects of the invention, it understood that various modifications will be apparent to those skilled in the art without departing for the scope and spirit of the invention as defined in the appended claims.

We claim:

1. A freeze capable compact fuel cell system to facilitate improved humidification and removal of excess water and trapped nitrogen gas from the fuel cell system, said fuel cell system comprising a plurality of fuel cells arranged in a stack, said stack arranged to permit oxygen or an oxygen containing gas to react with hydrogen or a hydrogen containing gas to generate electricity and produce first exhaust gas containing residual oxygen or residual oxygen and other gasses and second exhaust gas containing residual hydrogen, or residual hydrogen and other gasses, said fuel cell system comprising:
a) cathode inlet, cathode outlet, fluid connection between said cathode inlet and said cathode outlet; said cathode fluid connection being a gas passage and together with said cathode inlet and cathode outlet comprise a cathode side of the fuel cell;
b) integrated anode inlet in fluid connection with integrated merged anode outlet; said anode fluid connection being a gas passage and together with said anode inlet and said merged anode outlet comprise an anode side of said fuel cell system; said anode fluid connection separated from said cathode fluid connection by a proton exchange membrane;
c) coolant inlet and coolant outlet in fluid connection with each other;
d) a water transfer device in fluid connection with said integrated merged anode outlet, said water transfer device to receive water and other gasses from said second exhaust gas and equipped with a water separation membrane and fluid level indicator and further equipped with a first separator fluid outlet at one end thereof and a second separator fluid outlet at another end thereof;
e) a fluid conductor connected to said first outlet of said water transfer device; said fluid conductor equipped with a bleed valve at a first end thereof and a purge valve at a second end thereof; said bleed valve controlled and regulated by a differential pressure sensor; said bleed valve in fluid connection with said fluid connector between said cathode outlet and said cathode inlet; said purge valve controlled and regulated by a pressure sensor to vent excess anode fluid from said fuel cell system;
f) a cathode humidity valve in fluid communication with said second end of said water transfer device at a first end thereof, and in fluid communication with the cathode inlet at a second end thereof, to permit the flow of water from the water transfer device to the cathode inlet to humidify said cathode inlet.

2. The freeze capable compact fuel cell system design of claim 1, wherein at said merged anode outlet is in fluid communication with said cathode inlet.

3. The freeze capable compact fuel cell system of claim 1, wherein said second exhaust includes trapped nitrogen gas from the anode side and said differential pressure sensor controls the flow rate of the bleed valve to vent said trapped nitrogen gas to remove excess nitrogen gas from the anode side of the fuel cell system.

4. The freeze capable compact fuel cell system of claim 3, wherein said differential pressure sensor control of the bleed valve is based upon a model contained in an electronic control module.

5. The freeze capable compact fuel cell system of claim 4, wherein said model is a calculation of content of the first exhaust gas based upon operating conditions of the fuel cell system.

6. The freeze capable compact fuel cell system of claim 1, wherein the fluid connection between the cathode outlet and the cathode inlet has a length determined to reduce the effect that freezing of water may have to the operation of the fuel cell system.

7. The freeze capable compact fuel cell system of claim 1, wherein said water separation membrane is comprised of a polymer of the monomers poly, sulfonic acid and poly [perfluorosulfonic] acid.

8. A freeze capable compact fuel cell system design for small vehicles to facilitate integration of the fuel cell system with a vehicle body, said fuel cell system design comprising:
a) a plurality of fuel cell assemblies equipped with a plurality of reactant gas passages provided with a common inlet reactant gas passage and a common outlet reactant gas passage; coolant passages in fluid communication with an inlet for coolant and an outlet for coolant, a cathode inlet, a cathode outlet, fluid connection between said cathode inlet and said cathode outlet, and integrated anode inlets in fluid connection with integrated merged anode outlet;
b) a water transfer device in fluid connection with said merged anode outlet, said water transfer device equipped with a fluid level indicator and a water reservoir, and further equipped with a first water transfer device fluid outlet at one end thereof and a second water transfer fluid device fluid outlet at another end thereof;
c) a fluid conductor connected to said first outlet of said separator; said fluid conductor equipped with a bleed valve at a first end thereof and a purge valve at a second end thereof; said bleed valve controlled and regulated by a differential pressure sensor; said bleed valve in fluid connection with said fuel cell cathode outlet and said cathode inlet; said purge valve controlled and regulated by a pressure sensor to remove excess anode fluid from said fuel cell system;
d) a cathode humidity valve in fluid communication with said second end of said separator at a first end thereof, and in fluid communication with the cathode inlet to humidify said cathode.
e) said plurality of fuel cells present and configured as pairs in a stack arranged as adjacent segments separated by a separator segment, said separator segment forming contiguous structural connection between each pair of at least two fuel cell segments.

9. The compact fuel cell system design of claim 8, wherein at least one said anode outlet is in fluid communication with said cathode inlet.

10. The compact fuel cell system design of claim 8, wherein said plurality of gas passages comprises a group of anode passages and a group of cathode passages, said anode passages in fluid communication with anode inlets and a merged integrated anode outlet; said cathode passages in fluid communication with said cathode inlet and said cathode outlet.

11. The compact fuel cell system design of claim 8, further including a catalyst in close association with said proton exchange membrane to permit said hydrogen or hydrogen containing gas to react with said oxygen or oxygen containing gas at a relatively low temperature.

12. The compact fuel cell system design of claim 11, wherein said temperature is in the range of about 60 to 80 degrees Celsius.

13. The compact fuel cell system design of claim 8, wherein said water transfer device is equipped with at least one membrane to separate water from the anode exhaust gas; said water transfer device to condense said water to be held by said water transfer device preparatory for transfer to other parts of the fuel cell system, and vents other constituents of said anode exhaust gas through said purge valve.

14. The compact fuel cell system design of claim 13, wherein said water transfer device is equipped with a plurality of membranes to separate water from the anode exhaust gas.

15. The compact fuel cell system design of claim 8, wherein said gas at the anode inlet is hydrogen.

16. The compact fuel cell design of claim 8, wherein said oxygen containing gas at the cathode inlet is ambient air.

17. The compact fuel cell system of claim 13, wherein said membrane is a copolymer of poly[perfluorosulfonic] acid.
